(19) United States
(12) Patent Application Publication
(10) Pub. No.: US 2001/0042451 A1
(43) Pub. Date: Nov. 22, 2001

(54) Converting press

(75) Inventors: Jean-Bernard De Dompierre, Echandens (CH); Ha-Simon Tran, Lausanne (CH); Bernard Jaquet, Rue (CH)

Correspondence Address: OSTROLENK FABER GERB & SOFFEN, 1180 AVENUE OF THE AMERICAS, NEW YORK, NY, 100368403

(73) Assignee: Bobst S.A.

(21) Appl. No.: 09/855,926

(22) Filed: May 15, 2001

(30) Foreign Application Priority Data
May 16, 2000 (SZ) 2000 0960/00`

(51) Int. Cl. B30B 9/00

(52) U.S. Cl. 100/94

(57) ABSTRACT

Converting press for paper or cardboard sheets including a waste stripping station and/or a blanking station with a pull-out chase (1, 2, 3, 4) comprising a pair of horizontal transverse rails (5, 11) receiving an upper stripping tool, respectively a blanking tool, from which the first rail (5) is fixed compared to aforesaid chase and from which the second rail is movable in a longitudinal direction, and whose profile allows receiving and maintaining in an operational waste stripping position, respectively blanking position, either a pull-out chase of an upper tool or an upper stripping board, respectively blanking board.

The present invention relates to a converting press for paper or cardboard sheets including a waste stripping station with a tool supporting chase comprising a pair of horizontal transverse rails to which is secured an upper stripping tool.

The present invention also relates to a converting press for paper or cardboard sheets including a blanking station with a tool supporting chase comprising a pair of horizontal transverse rails, to which is secured an upper blanking tool.

The present invention also relates to a converting press for paper or cardboard sheets, including at the same time a waste stripping station and a blanking station such as described above.

The converting presses for paper, solid board or corrugated board are using for each order a whole range of specific converting tools for a specific work. Such a whole range of tools includes specifically:

a makeready protection plate

a makeready sheet

a cutting die

a cutting plate comprising the cutting counterparts

a waste upper stripping tool

a central stripping board

a lower stripping frame comprising telescopic tools for waste capture

an upper blanking tool

a lower blanking tool.

The waste upper stripping tool as well as the upper blanking tool can be a pull-out frame of standard size, whose front and back sides show profiles securing to and sliding onto profiled fastening devices, such as secured transverse rails and interdependent from the reference stations. The terms “longitudinal” and “transverse” when the direction of a body is concerned, “front”, “back” and “lateral” when a side of a station is concerned, are used with reference to the way of run of the sheets in the machine. The pull-out frame can include several crossbars, on whose are secured a range of strippers. The locations of the crossbars and the strippers into the pull-out frame are subject to change and have to be defined by the work to be achieved. The fitting up of their location is settled outside the machine, preferably on a presetting table, and is dealing with the preparation of the tool. This operation is relatively tiresome, but is achieved in “masked time” independently from the machine in production.

For short and repetitive orders, an upper tool is often used, called die or upper stripping board, respectively die or upper blanking board, made up of a rectangular wooden board, on which are definitively secured strippers of various shapes, corresponding to this specific work. The wooden die itself is assembled inside a pull-out frame. This frame is then settled into the corresponding station. If necessary, the board mus be readjusted in position and reinstalled within the frame.

The whole range of the tools mentioned above must be laid out in an extremely precise way in the various stations of the press at the start up of each work. Particularly in the case of short orders, the productivity of the unit depends on a large scale on the rapidity of the positioning and the setting of the tools.

The aim of the present invention is to make easier and faster the positioning and the setting of the upper strippping tool and/or the upper blanking tool, particularly in the case of short and repetitive orders.

This aim is reached with a kind of a converting press as initially defined by the fact that the stripping station comprises a pair of transverse horizontal rails from whose the first one is fixed compared to the tool supporting chase and the second one is movable in a longitudinal direction, and from which the profiles ensure receiving and maintaining, in an operational waste stripping position, either a pull-out frame of an upper stripping tool or an upper stripping board.

This aim is also reached with a kind of a converting press such as the one previously defined by the fact that the blanking station comprises a pair of transverse horizontal rails from whose the first one is fixed compared to the tool supporting chase and the second one is movable in a longitudinal direction, and from which the profiles ensure receiving and maintaining, in an operational blanking position, either a pull-out frame of an upper blanking tool or an upper blanking board.

A waste stripping station and/or a blanking station, according to the invention, allow overcoming the assembly and setting operations of an upper waste stripping board, respectively of an upper blanking board in a pull-out frame. The boards are directly assembled in the station. Resulting from this is a time saving during the preparation of the press between two operations. It also has as a result a saving in the number of the tooling elements to be used. The fact that the second rail is movable allows the spacing adjusting of the pair of rails to various sizes of boards.

The rails of the station can comprise an upper part whose profile is complementary to the profile of a pull-out frame and a lower part whose profile is complementary to the profile of an upper board, the shaped parts of the two rails facing each other.

The rail located in front of the station preferably presents at the level of the shaped part receiving an upper board, a centering block intended for centering into the machine this upper stripping or blanking board. To deal with possible errors of manufacture of the board, the centering block is preferentially transversely adjustable by a micrometric setting device.

The station includes preferably means allowing a push on the movable rail, longitudinally, into the direction of the fixed rail. Acting so, when the upper tool is settled, it is tightly secured between the fixed rail and the movable rail.

The aforesaid means used to push the movable rail forward to the fixed rail can include at least one spring acting with a permanent pushing on the movable rail into the direction of the fixed rail and at least one cylinder, whose setting into operation by the conductor deletes and overcomes the acting of the spring(s), allowing the loosening and the tools changing.

The movable rail, which is preferably the back one, can be held by at least one support, itself or themselves secured on a moving mean, to be used by the conductor. Thus, the station can deal with upper boards of variable sizes. Furthermore, the movable rail can be carried by two holders secured each one onto a rack with longitudinal moving.

Other characteristics and advantages of the invention will occurr to the one in deal with this technical field with the description of a chosen production way with reference to the drawing, in which:

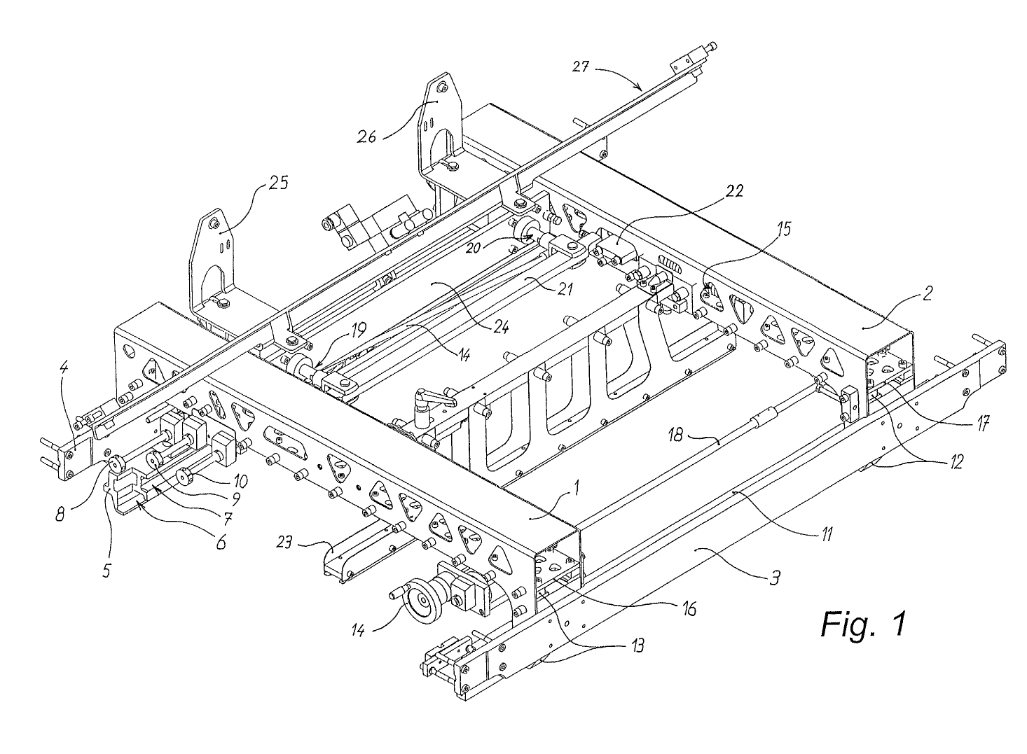

FIG. 1 is a prospect sight of a chase part of a stripping station of a converting press with a pair of rails ensuring the use of an upper stripping tool.

FIG. 1 shows an upper tool supporting chase of a waste stripping station of a converting press with two longitudinal beams 1 and 2 and two transverse beams 3 and 4. One front rail 5, transverse and horizontal, is hanging onto the longitudinal beams 1 and 2 by two vertical members (not shown on fig.). Rail 5 shows on its back side two grooves, a lower groove 6 being able to deal with the edge of an upper stripping board and an upper groove 7, into which a rib of a pull-out frame of an universal stripping tool can be sliding. Rail 5 remains normally secured compared to the tool supporting chase, as well during the operation of the press as during the tools changing. However, to overcome slight errors in manufacturing or setting an upper tool, manual controllable devices are intended for the micrometric fitting of the position : the knurled knob 8 allows the adjustment of the transverse position of the centering block intended for the centering into the machine of an upper board. The knurled knobs 9 and 10 are acting, by means of a rod 14 and levers, respectively and in an independent way the one from the other on the two vertical standards onto whose rail 5 is hanging, so as to allow correcting the longitudinal position of this one and/or its angular position. These three micrometric fitting devices are equipped with a display, which allows, for repetitive works, storing the setting values in memory.

In front of fixed rail 5 stands a movable back rail 11, parallel to the fixed rail 5. Rail 11 also shows a lower groove being able to receive the back edge of an upper stripping board and an upper groove into which a complementary rib of an upper pull-out frame of an universal stripping tool can be sliding.

The movable back rail 11 is carried by the vertical legs of two crosswise bearings 12 and 13, whose horizontal legs are supporting toothed wheels, whose rotation can be held on and which are gearing with two longitudinal racks. These racks (not shown on FIG. 1) are assembled below two horizontal plates 16 and 17 interdependent of beams 1 and 2, and can be longitudinally sliding of a few millimetres under those plates. The manual control 14, which is acting on the toothed wheels, and this simultaneously on the two sides of the station thanks to rod 18, allows the movable rail 11 to move longitudinally, so as to fit its location to the length of an upper stripping board. A pair of springs under constant pressure, one of whose, the 15, is shown on FIG. 1, are longitudinally secured respectively on plates 16 and 17. Each spring, of which one edge is interdependent of the plate, is acting as pushing with its other edge on a block 22, interdependent of one of the racks, pushes this latter forwards the station, and thus grips the upper tool between rails 5 and 11.

Two jacks 19 and 20, secured on a fixed transverse beam 24, interdependent of the machine frame by two fastening tabs 25 and 26 and by a transverse beam 27, can be put into operation by the conductor when the frame which is supporting the upper stripping tool is in high position. Jacks 19 and 20 are carrying a transverse bar 21. When the tool supporting chase is in high position, the blocks 22 are coming to the same level than the edges of the transverse bar 21, so that under pressure of the jacks, the transverse bar 21 is pushing onto a lenghtening of blocks 22 extending beams 1 and 2, refraining the pushing of springs 15 and releasing the upper tool, which can be easily removed by the conductor.

One can note that bearings 12 and 13 of the movable rail, racks, springs 15 and jacks 19, 20 are symmetrically arranged compared to a vertical plane driving through a longitudinal central axis, so called “axis-machine”.

One can also note on FIG. 1 a support beam 23. This beam 23 is movable. It is intended to lead on the top of an upper stripping board so as to maintain the flatness of this latter during the rising and the lowering of the tool supporting chase.

The blanking station is intended to be equipped with the same tool supporting chase.

1. Converting press for paper or cardboard sheets including a waste stripping station with a tool supporting chase comprising a pair of horizontal transverse rails to which is secured an upper stripping tool, characterized in the fact that the first rail (5) is fixed compared to said chase and the second rail (11) is movable in a longitudinal direction, and in that the profile of the two rails ensures receiving and maintaining in an operational waste stripping position either a pull-out frame of an upper stripping tool or an upper stripping board.

2. Converting press for paper or cardboard sheets including a blanking. station with a tool supporting chase which comprises a pair of horizontal transverse rails, to which is secured an upper blanking tool, characterized in the fact that the first rail is fixed compared to said chase and the second rail is movable in a longitudinal direction, and in that the profile of the two rails ensures receiving and maintaining in an operational blanking position either a pull-out frame of an upper blanking tool or an upper blanking board.

3. Converting press for paper or cardboard sheets including a waste stripping station, according to claim 1, and a blnking station, according to claim 2.

4. Converting press according to anyone of claims 1 to 3, characterized in the fact that each said rails (5, 11) comprises, on its side facing the other rail, a first shaped part (7), of which the profile is complementary to the external one on a transverse side of a pull-out frame, and a second shaped part (6), of which the profile is complementary to the edge of an upper board and, in particular, in that the said first shaped part is located above said second shaped part.

5. Converting press according to claim 4, characterized in the fact that the said second part of the front rail comprises a centering block, intended for centering in the machine an upper board.

6. Converting press according to claim 5, characterized in the fact that the pull-out chase comprises the micrometric means of fitting (8) of a transversal position of the said centering block.

7. Converting press according to one of claims 4 to 6, characterized in the fact that the pull-out chase comprises the micrometric means of fitting (9, 10) of the longitudinal and/or angular position of the said fixed rail (5).

8. Converting press according to one of claims 6 or 7, characterized in the fact that the said micrometric means of fitting (8, 9, 10) show a storable display of their fitting value.

9. Converting press according to anyone of the preceding claims, characterized in the fact that the station(s) comprise tightening means to maintain the upper tool in an operational position and in that the said tightening means include at least one spring (15) acting with permanent pressure on the movable rail (11) in a longitudinal direction towards the fixed rail (5) and at least one jack (19, 20), whose setting into operation deletes and overcomes the strength of the spring.

10. Converting press according to claim 9, characterized in the fact that the movable rail (11) is carried by at least one support (12, 13) allowing a longitudinal translation of the movable rail (11) by a gearing device secured to the support by an elastic device.
